(19) United States
(12) Patent Application Publication
(10) Pub. No.: US 2002/0172782 A1
(43) Pub. Date: Nov. 21, 2002

(54) Ethylene/vinyl ester copolymer tape for a tamper evident container

(76) Inventors: Ronald D. Moffitt, Moore, SC (US); Charles P. Kannankeril, North Caldwell, NJ (US); Marvin R. Havens, Greer, SC (US); Peter R. Guerra, Pompton Lakes, NJ (US); Rengan Kannabiran, Wayland, MA (US)

Correspondence Address: Mark B. Quatt, Cryovac, Inc., P.O. Box 464, Duncan, SC, 29334, US

(21) Appl. No.: 09/861,119

(22) Filed: May 18, 2001

(51) Int. Cl. B32B 1/02

(52) U.S. Cl. 428/34.1; 428/522

(57) ABSTRACT

A tape for a tamper evident container includes an ethylene/vinyl ester copolymer, wherein the ethylene/vinyl ester copolymer has a melt index of between 5 and 3,000, and a weight average molecular weight of between 5,000 and 100,000 Daltons. The tape can be crosslinked. A tamper evident container includes a first portion; an opening capable of providing access to the interior of the tamper evident container; a closure portion arranged to be superposable with the first portion; an adhesive, applied to the first portion or closure portion; and a tape disposed, on superposition of the first portion and the closure portion, adjacent to the opening, wherein the tape comprises an ethylene/vinyl ester copolymer having a melt index of between 5 and 3,000, and a weight average molecular weight of between 5,000 and 100,000 Daltons.

### FIELD OF THE INVENTION

The present invention relates to a tape for a tamper evident container characterized by good heat sealability and frangibility.

### BACKGROUND OF THE INVENTION

It is known that banking establishments and the like use containers for transmitting valuables, for example specified sums of money, securities, cash in transit (CIT), etc. from one department to another. The system operated by such establishments is such that it is readily possible to ascertain whether a tamper evident container has been stolen in transit. However it is ordinarily more difficult to ascertain whether the tamper evident container containing the valuables has been opened in transit and then resealed after some of the contents have been removed. In order to overcome this problem, tamper evident containers have been provided wherein an attempt to gain access to the interior of the tamper evident container becomes visibly apparent.

Typically, the walls of such tamper evident containers are formed of a single sheet material folded to form a continuous bottom portion, and sealed along its lateral edges, to form an envelope with an opening which gives access to the interior of the tamper evident container. Alternatively, two sheets of material can be sealed together at their congruent bottom and side edges to form an envelope with an opening. The tamper evident containers include a closure mechanism to provide the capability of closing the tamper evident container after an article has been inserted therein.

In one embodiment, the tamper evident container (e.g. in the form of an envelope) is formed from a first sheet portion forming a first (usually front) wall or panel of the container, and a second sheet portion forming a second (usually back) wall or panel of the container, the second sheet portion being longer than the first sheet portion, and including an adhesive strip covered with a release liner or strip. A tamper evident device, which can be the adhesive strip itself, or a separate device, is also located on the interior surface of the second panel, or on the exterior surface of the first panel. The two panels form an opening therebetween. In practice, the product to be packaged (e.g. cash or securities) is placed in the container, the release liner is removed from the adhesive strip, and the extended upper portion of the second wall is folded over and pressed into contact with the exterior wall of the first sheet to activate the tamper evident seal. This provides a closed container with a tamper evident seal.

In another embodiment, the tamper evident container (e.g. in the form of an envelope) has two panels formed from a first and a second sheet portion respectively as described above, but in which both sheets are of substantially the same length. The opening in the container is essentially the open mouth formed at one end of the container between the upper edges of the first and second panels. An adhesive strip is located on the interior side of one of the panels. A tamper evident device, which can be the adhesive strip itself, or a separate device, is also located on the interior surface of one of the panels. As above, a release liner will typically be removed from the adhesive panel. The panels are then pressed together to close the container, and provide a closed container with a tamper evident seal.

In a third embodiment, the two panels are of substantially equal length, but a break or opening in one of the panels provides initial access to the interior of the container. The opening can be as thin as a slot, or can form a more significant part of one panel or wall of the container. In this embodiment, the adhesive strip can be installed at any appropriate place on the container, acting as or in conjunction with a tamper evident device, and capable of sealing to another portion of the container so as to seal the container closed.

Closure is typically effected by means of a band of high-tack adhesive which is applied across the closure portion or the portion having the opening, for example from the molten state, from transfer tape, solvent cast or in the form of a discrete tape. The adhesive may be pressure sensitive adhesive, and suitable adhesives include thermoplastic hot melt adhesives, silicone adhesives, acrylic pressure sensitive adhesives, solvent cast adhesives, UV (ultraviolet) or EB (electron beam) cured acrylic adhesives, and the like.

Such adhesives are required to have high initial tack with respect to the surface of the sheet material and also to have high adhesive and cohesive strength. In order to provide a visible indication of any attempt to open the tamper evident container by separating the closure portion and the portion having the opening, the adhesive should be strong enough to cause stretching, tearing, or other permanent mechanical distortion of the portions upon attempted opening of the container. If desired, perforations or serrated edges may be provided in the closure portion to indicate tearing and emphasize the mechanical distortion. The adhesive can also be formulated to provide evidence of chemical attack.

With the exception of silicone adhesives, adhesives suitable for the closure of tamper evident containers have a softening temperature which is below the melting point of the closure portion and of the sheet material. The softening temperature is commonly in the range of between 50° C. and 90° C. Accordingly, by the local application of heat, an unauthorized person can open and reseal the tamper evident container without any visible indication that the tamper evident container has been opened.

To discourage this practice, thermochromic inks have been used in tamper evident containers. These inks are formulated to develop a permanent, non-reversible, and visibly evident color change when the adhesive on the envelope is exposed to heating. In this way, if unauthorized access to e.g. a tamper evident container is attempted by means of local application of heat to an adhesive on the envelope, a color change in the ink makes this evident.

Although these systems provide a good visual indication of unauthorized tampering with the tamper evident container or other article, such systems tend to be expensive, requiring the extra step and cost associated with applying a thermochromic ink to a tape, or to a sheet portion of a container. An additional consideration is that the ink system should be compatible with the substrate onto which the ink is coated or otherwise applied.

It is therefore desirable to provide a relatively economic and effective alternative to conventional tapes and containers. The alternative should desirably not require printing a message, or other post processing, to make the container tamper evident.

It is known to use an ethylene/acrylic acid copolymer (EAA) in the form of a thin, narrow film strip, to function as a tape for a tamper evident container. This tape exhibits frangibility, i.e. physically distorts or breaks up relatively easily if the tape is tampered with. Unfortunately, a problem associated with the use of this material is that the same grades of EAA that exhibit frangibility when used in a tape, are also very difficult and expensive to process efficiently. Such EAA is typically very tacky and sticky.

The inventors have found that an effective tape for a tamper evident container can be made from ethylene/vinyl ester copolymer (EVE), such as ethylene/acrylic acid copolymer (EAA), ethylene/methacrylic acid copolymer (EMAA), or ethylene/vinyl acetate copolymer (EVA), having a melt index (ASTM D-1238, condition 190/2.16) of between and 3,000, and a weight average molecular weight (M_{w}) of between 5,000 Daltons and 100,000 Daltons.

The inventors have also found that an effective tape for a tamper evident container can be made from ethylene/vinyl ester copolymer (EVE), such as ethylene/acrylic acid copolymer (EAA), ethylene/methacrylic acid copolymer (EMAA), or ethylene/vinyl acetate copolymer (EVA), having a melt index (ASTM D-1238, condition 190/2.16) of between 5 and 3,000, and a weight average molecular weight (M_{w}) of between 5,000 Daltons and 100,000 Daltons, where the EVE is cross-linked. This embodiment results in improved processability of the tape when being made, and when being applied to a container such as an envelope.

### SUMMARY OF THE INVENTION

In a first aspect, a tape for a tamper evident container comprises an ethylene/vinyl ester copolymer, wherein the ethylene/vinyl ester copolymer has a melt index (ASTM D-1238, condition 190/2.16) of between 5 and 3,000, and a weight average molecular weight (M_{w}) of between 5,000 Daltons and 100,000 Daltons.

In a second aspect, a tape for a tamper evident container comprises a cross-linked ethylene/vinyl ester copolymer, wherein the ethylene/vinyl ester copolymer has a melt index (ASTM D-1238, condition 190/2.16), before crosslinking, of between 5 and 3,000, and a weight average molecular weight (M_{w}), before crosslinking, of between 5,000 Daltons and 100,000 Daltons.

In a third aspect, a tamper evident container comprises a first portion; an opening capable of providing access to the interior of the tamper evident container; a closure portion arranged to be superposable with the first portion; an adhesive, applied to the first portion or closure portion; and a tape disposed, on superposition of the first portion and the closure portion, adjacent to the opening, wherein the tape comprises an ethylene/vinyl ester copolymer having a melt index (ASTM D-1238, condition 190/2.16) of between 5 and 3,000, and a weight average molecular weight (M_{w}) of between 5,000 Daltons and 100,000 Daltons.

In a fourth aspect, a method of making a tape for a tamper evident container comprises providing an ethylene/vinyl ester copolymer having a melt index (ASTM D-1238, condition 190/2.16) of between 5 and 3,000, and a weight average molecular weight (M_{w}) of between 5,000 Daltons and 100,000 Daltons; and extruding a tape comprising the ethylene/vinyl ester copolymer.

In a fifth aspect, a method of making a tape for a tamper evident container comprises extruding a tape comprising an ethylene/vinyl ester copolymer having a melt index (ASTM D-1238, condition 190/2.16) of between 5 and 3,000, and a weight average molecular weight (M_{w}) of between 5,000 Daltons and 100,000 Daltons; and irradiating the extruded tape.

All compositional percentages used herein are presented on a “by weight” basis, unless designated otherwise.

Definitions

“Container” herein refers to bags, pouches, envelopes, or other articles which can store a product.

“Loss modulus” herein refers to the parameter that is related to the viscous dissipation of a material undergoing small cyclic deformations, generally obtained by dynamic mechanical spectroscopic techniques. Loss modulus is measured in pascals (Pa), is determined by ASTM D 5026, and is typically designated as G″.

“Loss tangent” (tan delta )herein refers to the ratio between the loss modulus and storage modulus and is generally represented by “tan delta”. Loss tangent, or tan delta, is typically designated as G″/G′.

“Mechanical evident” herein refers to a continuous or discontinuous layer or layers, coating, printing, or messaging that displays a visual change in color, shape, size, or pattern when stretched, torn, or otherwise distorted, or when an attempt is made to open a container which includes the mechanical evident layer.

“Message” herein refers to any alphabetic, numeric, or alphanumeric message, warning, or statement that communicates to the viewer that tampering has occurred or been attempted.

“Solvent evident” refers to a continuous or discontinuous layer, coating, printing, or messaging that displays a visual change in color, shape, size, or pattern when contacted with a solvent.

“Storage modulus” herein refers to the parameter that is related to the elastic behavior of a material undergoing small cyclic deformations, generally obtained by dynamic mechanical spectroscopic techniques. Storage modulus is measured in pascals (Pa), is determined by ASTM D 5026, and is typically designated as G′.

“Tape for a tamper evident container” herein refers to a discrete strip of material which can be manufactured and then, simultaneously or subsequently, can be glued, sealed or otherwise adhered to a larger panel or sheet that forms or will ultimately form a portion of a container that, when sealed, will exhibit tamper evident properties. “Tape for a tamper evident container” herein also refers to an integral portion of a container or a panel thereof, which portion provides tamper evident properties when the container is sealed.

“Thermochromic” herein refers to an ink that exhibits a permanent, non-reversible, and visibly evident color change when exposed to heat.

### BRIEF DESCRIPTION OF THE DRAWING

A detailed description of preferred embodiments of the invention follows, with reference to the attached drawing, wherein:

FIG. 1 is a graph plotting EVE crosslinked at different dosages, and showing the effect of electron-beam radiation on zero-shear viscosity and relaxation times.

### DETAILED DESCRIPTION OF THE INVENTION

The present invention is directed to a new tape for a tamper evident container which will show distortion or other destructive indications when the container is tampered with. In one preferred embodiment, a low molecular weight EAA copolymer with a relatively low maximum value of the loss tangent minima at −46° C., is extruded in a conventional extrusion, extrusion coat, or coextrusion process. The EAA is thus made into a tape which can be applied to an envelope for use in tamper evident applications.

The tape of the present invention preferably exhibits several features.

For example, unauthorized entry into a tamper evident container is sometimes attempted by heating the adhesive that is holding the container closed. This heating is continued until the adhesive is softened, and the holding power of the adhesive diminishes sufficiently to open the container to gain access to its contents. The tape of the invention is processable, i.e. can be extruded and handled without the excessive stickiness or tackiness typical of conventional EAA resins. Winding and unwinding of the tape, for example, is less prone to sticking problems when using the tape of the invention. Additionally, the tape of the invention is useful in providing visual evidence of distortion at high temperatures, as discussed above. Optionally, colorants and fillers can be added.

In another example, unauthorized entry into a tamper evident container is sometimes attempted by exposing the adhesive which is holding the container closed, to very cold temperatures on the order of −46° C., by spraying a freon spray onto the container in the area of the adhesive after closing the container. The tape of the invention is frangible at low temperatures. If an effort is made to loosen the adhesive by exposure to freon, a visual evidence of tampering will result. Thus, visually evident distortion will occur at low temperatures.

A suitable EVE for use in the present invention has a melt index of 1300 (ASTM D-1238, condition 190/2.16). When a seal bar is applied to a tape of this construction, to seal the tape to the LLDPE of the security envelope, most of the EVE melts and flows out from under the seal bar. This results in a weak seal. Thus, when using such an EVE, it is desirable to adhere the tape to the container by adhesive or by some alternative means.

To remedy the poor heat sealability, in another aspect of the invention, the EVE tape, or EVE pellets to be processed into a tape, are crosslinked, e.g. by exposing the tape or pellets to electron-beam irradiation to electronically crosslink the EVE and result in a cross-linked tape. Electronic crosslinking of high melt index EVE, or a tape made therefrom, renders the material heat sealable to a high melt index film substrate. Electronic crosslinking increases the extensional and shear viscosities, and extends the viscoelastic relaxation times of the resulting resin system. It is believed that the increases in these rheological parameters contribute to the reduction in adverse squeezing flow effect during heat sealing without compromising the chain mobility that facilitates the development of strong heat seals.

A suitable EVE for use in the present invention has a minimum loss tangent value, at a temperature of between −50° C. and 0° C., of no more than 0.03. Thus, the minima for the loss tangent curve will be less than or equal to 0.03.

This embodiment of the invention thus provides a method for increasing the shear viscosity of a high melt flow ethylene-acrylic acid copolymer resin or other EVE resin, thus reducing the squeeze flow of that resin out from under the seal bar during heat sealing.

Any appropriate tamper evident envelope geometry, including any tamper evident tape, can be used in connection with the invention. Various container designs disclosed in U.S. Pat. No. 4,712,729 (Craig), U.S. Pat. No. 5,205,649 (Fullerton), U.S. Pat. No. 5,352,041 (Fullerton), U.S. Pat. No. 5,631,068 (Smith), U.S. Pat. No. 5,635,917 (Todman), and U.S. Pat. No. 5,798,169 (Smith), all incorporated herein by reference in their entirety, are suitable for use in connection with the present invention.

Also, although not preferred, the tamper evident devices of U.S. Ser. No. 60/143,210 filed on Jul. 9, 1999 and refiled as U.S. Ser. No. 09/524,946 on Mar. 14, 2000; and U.S. Ser. No. 08/999,179 filed on Dec. 29, 1997, can be used in connection with the present invention, and are both incorporated herein by reference in their entirety. U.S. Ser. No. 09/524,946 discloses an article, such as a tamper evident container, including an indicator having a first layer including a thermochromic ink composition, and a second layer, disposed on the first layer, having a composition different from the ink composition of the first layer. The first and/or second layer can be in the form of a message, including a change in color, shape, or pattern, even if not numeric, alphabetic, or alphanumeric. The second layer can be a non-thermochromic ink. U.S. Ser. No. 08/999,179 discloses a saliva-evident tamper evident device.

The additional tamper evident devices can comprise a composition such as thermochromic ink; non-thermochromic ink; aqueous evident ink; mechanical evident ink; solvent evident ink; and/or deactivating agent.

### EXAMPLE 1

A tape was made, comprising an 80 melt index EAA having a weight average molecular weight (M_{w}) of between 5,000 Daltons and 100,000 Daltons. When heat sealing was attempted to attach the tape to the linear low density polyethylene substrate of a thermoplastic envelope, the pressure exerted by the heat seal bar caused the high melt flow ethylene-acrylic acid copolymer to melt and flow out from under the seal bar. Even at seal bar pressures as low as 3 psig, most of the tape was squeezed out of the sealing area.

A separate problem associated with EAA is that typical EAA resins are very tacky, and will undesirably stick to the TEFLON® tape or ribbon often used on heat seal bars.

The heat sealability of the tape of Example 1 was greatly improved by electronic crosslinking of that tape. It was observed that electronic crosslinking increased the extensional and shear viscosities, and extended the viscoelastic relaxation times, of the EAA resin system.

### COMPARATIVE EXAMPLE 1

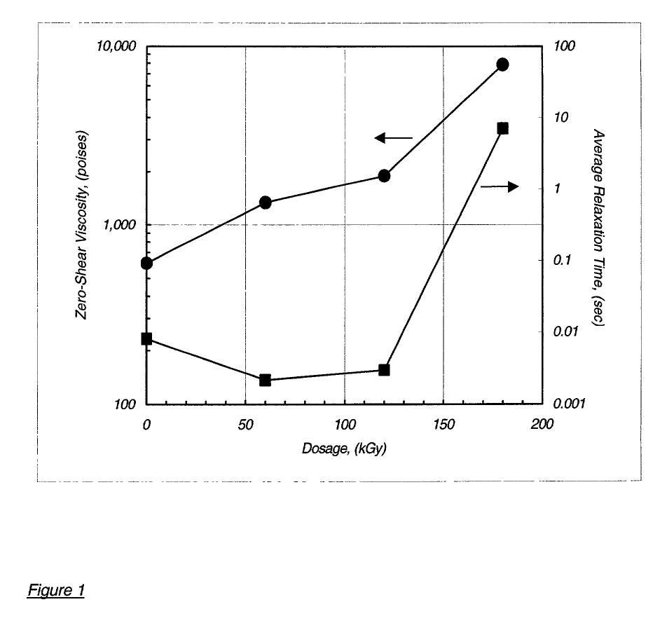

A commercially available EAA, Dow PRIMACOR® 59901 available from Dow, in the form of resin pellets, was not exposed to an industrial electron beam. Thus, the listed dosage of FIG. 1 is 0 kGy.

### EXAMPLE 2

A commercially available EAA, Dow PRIMACOR® 59901 available from Dow, in the form of resin pellets, was exposed to an industrial electron beam at a dosage of 60 kGy.

### EXAMPLE 3

A commercially available EAA, Dow PRIMACOR® 59901 available from Dow, in the form of resin pellets, was exposed to an industrial electron beam at a dosage of 120 kGy.

### EXAMPLE 4

A commercially available EAA, Dow PRIMACOR® 59901 available from Dow, in the form of resin pellets, was exposed to an industrial electron beam at a dosage of 180 kGy.

FIG. 1 is a graph showing the effect of electron-beam dosage, in kiloGrays, on zeroshear viscosity (in units of poises) and average relaxation time (in units of seconds) for Comparative Example 1 and Examples 2 through 4 above. The data was obtained from a Rheometrics RMS-800™ mechanical spectrometer using pressed disks irradiated at the specified levels.

The two properties, zero-shear viscosity and average relaxation time, are germane to the specific problem described above, and solved by the present invention. It can be seen that at electron-beam doses of greater than about 60 kiloGrays, both average relaxation time and zero-shear viscosity (in poises) increase. The advantage of crosslinking the EM is that it provides a method for increasing the shear viscosity of a high melt flow ethyleneacrylic acid copolymer resin while reducing the squeeze flow of that resin out from under the seal bar during heat sealing. The electronically-crosslinked tapes remained frangible at all dosage levels. A dosage of 180 kGy increased the zero-shear viscosity more than a factor of 44 and the average relaxation time by over 1,814 times the corresponding values observed for the virgin polymer.

In making a preferred tape from an EVE polymer, several factors must be considered. Heat sealability is a desirable property in commercial security envelope production, so that a tape can be economically and reliably adhered by heat sealing to a panel of an envelope, or to a sheet or web or thermoplastic blank that will eventually form such an envelope. In the present invention, the tape with the EVE polymer is preferably adhered by heat sealing to a panel or wall of the envelope, or to a sheet or web or thermoplastic blank that will eventually form such an envelope. In addition, the EVE resin, or the tape made therefrom, must have a high enough molecular weight (i.e. a low enough melt index) to insure that the resin will have sufficient strength to be capable of extrusion and forming into a tape. The tape should flow sufficiently under the influence of a heat seal bar so that it can be reliably adhered by heat sealing to a panel, but must not flow so much under heat and pressure that the material will leak out from under the seal bar. Also, the final tape must maintain its tamper evident properties at very high as well as very low temperatures, and exhibit distortion or frangibility respectively when an attempt is made to open the container.

The tamper evident container is preferably formed from a single strip of flexible thermoplastic sheet material. This sheet material can comprise any suitable material, preferably high density polyethylene, low density polyethylene, a blend of high density polyethylene and low density polyethylene, high density polyethylene with a filler, cellulose acetate, polyester, or polypropylene. The sheet material can be a monolayer film. However, those skilled in the art will understand that multilayer films can also be beneficially used in connection with tamper evident containers. An example is a film with a polymeric core or inner layer, and two outside layers of high density polyethylene The sheet material is folded laterally along a fold line to form a first portion and a second portion. The thermoplastic sheet material is preferably transparent, partially transparent or translucent, or a combination of opaque and transparent so as to make it easier to see evidence of tampering.

EVE materials for use in the present invention have a melt index ((ASTM D-1238, condition 190/2.16) of between 5 and 3,000, preferably between 50 and 2,800, such as between 100 and 2,500, between 500 and 2,200, and between 1,000 and 2,000, such as 1,300.

EVE materials for use in the present invention have a weight average molecular weight (M_{w}) of between 5,000 Daltons and 100,000 Daltons, preferably between 10,000 and 90,000 Daltons, such as between 20,000 and 80,000, between 30,000 and 70,000, and between 40,000 and 50,000 Daltons.

In crosslinked embodiments of the invention, the tape of the invention is irradiated at a dosage of preferably at least 60 kiloGrays, such as at least 80, at least 100, and at least 150 kiloGrays. The tape of the invention is irradiated at a dosage of preferably between 60 and 200 kiloGrays, such as between 80 and 180 kiloGrays, and between 100 and 160 kiloGrays.

It is to be understood that variations of the present invention can be made without departing from the scope of the invention, which is not limited to the specific embodiments and examples disclosed herein, but extends to the claims presented below.

What is claimed is:

1. A tape for a tamper evident container comprising an ethylene/vinyl ester copolymer, wherein the ethylene/vinyl ester copolymer has:
a) a melt index (ASTM D-1238, condition 190/2.16) of between 5 and 3,000, and
b) a weight average molecular weight (M_{w}) of between 5,000 Daltons and 100,000 Daltons.

2. The tape of claim 1 wherein the ethylene/vinyl ester copolymer is selected from the group consisting of ethylene/acrylic acid copolymer, ethylene/methacrylic acid copolymer, and ethylene/vinyl acetate copolymer.

3. The tape of claim 1 wherein the minimum loss tangent value of the ethylene/vinyl ester copolymer, at a temperature of between −50° C. and 0° C., is no more than 0.03.

4. The tape of claim 1 comprising a blend of the ethylene/vinyl ester copolymer with a second polymer higher in weight average molecular weight (M_{w}) than the ethylene/vinyl ester copolymer, where the second polymer comprises less than 70% by weight of the blend.

5. The tape of claim 4 wherein the second polymer comprises a material selected from the group consisting of low density polyethylene, very low density polyethylene, linear low density polyethylene, homogeneous ethylene/alpha olefin copolymer, high density polyethylene, poly(ethylene vinyl carboxylic acid) copolymer, poly(ethylene vinyl ester) copolymer, atactic polypropylene, syndiotactic polypropylene, isotactic polypropylene, polypropylene with block-distributed tacticity, poly(4-methyl pentene), ethylene propylene diene monomer, ethylene/polypropylene copolymer, atactic polystyrene, syndiotactic polystyrene, isotactic polystyrene, polystyrene with block-distributed tacticity, ethylene/styrene interpolymer, and cyclic olefin copolymer.

6. The tape of claim 1 wherein the tape comprises:
a) a first layer comprising wherein the ethylene/vinyl ester copolymer has
i) a melt index (ASTM D-1238, condition 190/2.16) of between 5 and 3,000, and
ii) a weight average molecular weight (M_{w}) of between 5,000 Daltons and 100,000 Daltons; and
b) a second polymeric layer.

7. The tape of claim 6 wherein the second polymeric layer comprises a material selected from the group consisting of low density polyethylene, very low density polyethylene, linear low density polyethylene, homogeneous ethylene/alpha olefin copolymer, high density polyethylene, poly(ethylene vinyl carboxylic acid) copolymer, poly(ethylene vinyl ester) copolymer, atactic polypropylene, syndiotactic polypropylene, isotactic polypropylene, polypropylene with block-distributed tacticity, poly(4-methyl pentene), ethylene propylene diene monomer, ethylene/polypropylene copolymer, atactic polystyrene, syndiotactic polystyrene, isotactic polystyrene, polystyrene with block-distributed tacticity, ethylene/styrene interpolymer, and cyclic olefin copolymer.

8. A tape for a tamper evident container comprising a cross-linked ethylene/vinyl ester copolymer, wherein the ethylene/vinyl ester copolymer has a melt index (ASTM D-1238, condition 190/2.16), before crosslinking, of between 5 and 3,000, and a weight average molecular weight (M_{w}), before crosslinking, of between 5,000 Daltons and 100,000 Daltons.

9. The tape of claim 8 wherein the ethylene/vinyl ester copolymer is selected from the group consisting of ethylene/acrylic acid copolymer, ethylene/methacrylic acid copolymer, and ethylene/vinyl acetate copolymer.

10. The tape of claim 8 wherein the minimum loss tangent value of the ethylene/vinyl ester copolymer, at a temperature of between −50° C. and 0° C., is no more than 0.03.

11. The tape of claim 8 comprising a blend of the crosslinked ethylene/vinyl ester copolymer with a second polymer higher in weight average molecular weight (M_{w}) than the ethylene/vinyl ester copolymer, where the second polymer comprises less than 70% by weight of the blend.

12. The tape of claim 8 wherein the second polymer comprises a material selected from the group consisting of low density polyethylene, very low density polyethylene, linear low density polyethylene, homogeneous ethylene/alpha olefin copolymer, high density polyethylene, poly(ethylene vinyl carboxylic acid) copolymer, poly(ethylene vinyl ester) copolymer, atactic polypropylene, syndiotactic polypropylene, isotactic polypropylene, polypropylene with block-distributed tacticity, poly(4-methyl pentene), ethylene propylene diene monomer, ethylene/polypropylene copolymer, atactic polystyrene, syndiotactic polystyrene, isotactic polystyrene, polystyrene with block-distributed tacticity, ethylene/styrene interpolymer, and cyclic olefin copolymer.

13. A tamper evident container comprising:
a) a first portion;
b) an opening capable of providing access to the interior of the tamper evident container;
c) a closure portion arranged to be superposable with the first portion;
d) an adhesive, applied to the first portion or closure portion, having a free surface so arranged as to seal the opening on superposition of the first portion and the closure portion; and
e) a tape which is capable of displaying a message, wherein the tape is disposed, on superposition of the first portion and the closure portion, adjacent to the opening,
wherein the tape comprises an ethylene/vinyl ester copolymer having:
(i) a melt index (ASTM D-1238, condition 190/2.16) of between 5 and 3,000, and
(ii) a weight average molecular weight (M_{w}) of between 5,000 Daltons and 100,000 Daltons.

14. The tamper evident container of claim 13 wherein the tape is heat sealed to the first portion.

15. The tamper evident container of claim 13 wherein the tape is heat sealed to the closure portion.

16. The tamper evident container of claim 13 wherein the ethylene/vinyl ester copolymer is selected from the group consisting of ethylene/acrylic acid copolymer, ethylene/methacrylic acid copolymer, and ethylene/vinyl acetate copolymer.

17. The tamper evident container of claim 13 wherein the minimum loss tangent value of the ethylene/vinyl ester copolymer, at a temperature of between −50° C. and 0° C., is no more than 0.03.

18. The tamper evident container of claim 13 wherein the tape comprises a blend of the ethylene/vinyl ester copolymer with a second polymer higher in weight average molecular weight (M_{w}) than the ethylene/vinyl ester copolymer, where the second polymer comprises less than 70% by weight of the blend.

19. The tamper evident container of claim 18 wherein the second polymer comprises a material selected from the group consisting of low density polyethylene, very low density polyethylene, linear low density polyethylene, homogeneous ethylene/alpha olefin copolymer, high density polyethylene, poly(ethylene vinyl carboxylic acid) copolymer, poly(ethylene vinyl ester) copolymer, atactic polypropylene, syndiotactic polypropylene, isotactic polypropylene, polypropylene with block-distributed tacticity, poly(4-methyl pentene), ethylene propylene diene monomer, ethylene/polypropylene copolymer, atactic polystyrene, syndiotactic polystyrene, isotactic polystyrene, polystyrene with block-distributed tacticity, ethylene/styrene interpolymer, and cyclic olefin copolymer.

20. The tamper evident container of claim 13 wherein the tape has been crosslinked by irradiation at a dosage of between 80 and 180 kiloGrays.
